(19) United States
(12) Patent Application Publication
(10) Pub. No.: US 2026/0040242 A1
(43) Pub. Date: Feb. 5, 2026

(54) INTEGRATED SYNCHRONIZATION SIGNALS

(71) Applicant: Samsung Electronics Co., Ltd., Suwon-si, (KR)

(72) Inventor: Hongbo Si, Allen, TX (US)

(21) Appl. No.: 19/267,353

(22) Filed: Jul. 11, 2025

Related U.S. Application Data
(60) Provisional application No. 63/679,324, filed on Aug. 5, 2024.

(51) Int. Cl. H04W 56/00; H04L 27/02; H04L 27/26

(52) U.S. Cl. CPC H04W 56/001; H04L 27/02; H04L 27/2601

(57) ABSTRACT

Apparatuses and methods for integrated synchronization signals. A method of a user equipment (UE) in a wireless communication system includes identifying a first waveform and a second waveform, identifying a first symbol in a first synchronization signal, and receiving the first synchronization signal. The first symbol is a second symbol using the second waveform multiplexed over a third symbol using the first waveform.

### CROSS-REFERENCE TO RELATED AND CLAIM OF PRIORITY

The present application claims priority under 35 U.S.C. § 119(e) to U.S. Provisional Patent Application No. 63/679,324 filed on Aug. 5, 2024, which is hereby incorporated by reference in its entirety.

### TECHNICAL FIELD

The present disclosure relates generally to wireless communication systems and, more specifically, the present disclosure is related to apparatuses and methods for integrated synchronization signals.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to integrated synchronization signals.

In one embodiment, a user equipment (UE) in a wireless communication system is provided. The UE includes a processor configured to identify a first waveform and a second waveform and identify a first symbol in a first synchronization signal. The first symbol is a second symbol using the second waveform multiplexed over a third symbol using the first waveform. The UE further includes a transceiver operably coupled to the processor.

In another embodiment, a method of UE in a wireless communication system is provided. The method includes identifying a first waveform and a second waveform, identifying a first symbol in a first synchronization signal, and receiving the first synchronization signal. The first symbol is a second symbol using the second waveform multiplexed over a third symbol using the first waveform.

In yet another embodiment, a base station (BS) in a wireless communication system is provided. The BS includes a processor configured to determine a first waveform and a second waveform and multiplex a second symbol using the second waveform over a third symbol using the first waveform to generate a first symbol in a first synchronization signal. The BS further includes a transceiver operably coupled to the processor. The transceiver is configured to transmit the first synchronization signal.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example synchronization signal/physical broadcast channel (SS/PBCH) block architecture according to embodiments of the present disclosure;

FIG. 6 illustrates an example on-off keying (OOK) waveform according to embodiments of the present disclosure;

FIG. 7 illustrates an example OOK waveform according to embodiments of the present disclosure;

FIG. 8 illustrates an example integrated synchronization signal according to embodiments of the present disclosure;

FIG. 9 illustrates an example integrated synchronization signal according to embodiments of the present disclosure;

FIG. 10 illustrates an example integrated synchronization signal according to embodiments of the present disclosure;

FIG. 11 illustrates a flowchart of an example UE procedure for receiving integrated low power (LP)-SSB and synchronization signal block (SSB) according to embodiments of the present disclosure; and

FIG. 12 illustrates an example method performed by a UE in a wireless communication system according to embodiments of the present disclosure.

### DETAILED DESCRIPTION

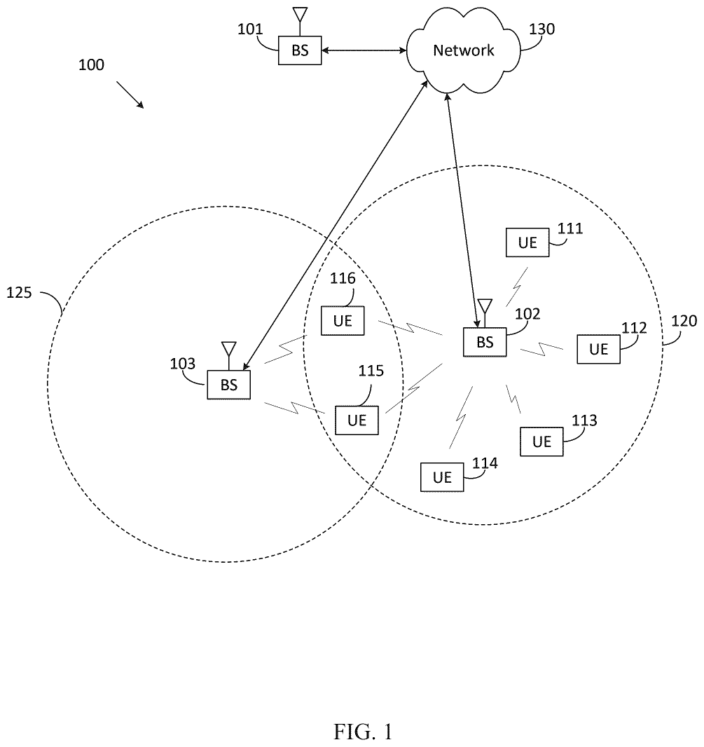

FIGS. 1-12, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 38.211 v18.0.0, “NR; Physical channels and modulation;” [REF 2] 3GPP TS 38.212 v18.0.0, “NR; Multiplexing and channel coding;” [REF 3] 3GPP TS 38.213 v18.0.0, “NR; Physical layer procedures for control;” [REF 4] 3GPP TS 38.214 v18.0.0, “NR; Physical layer procedures for data;” and [REF 5] 3GPP TS 38.331 v18.0.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for utilizing integrated synchronization signals. In certain embodiments, one or more of the BSs 101-103 include circuitry, programing, or a combination thereof to support integrated synchronization signals.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

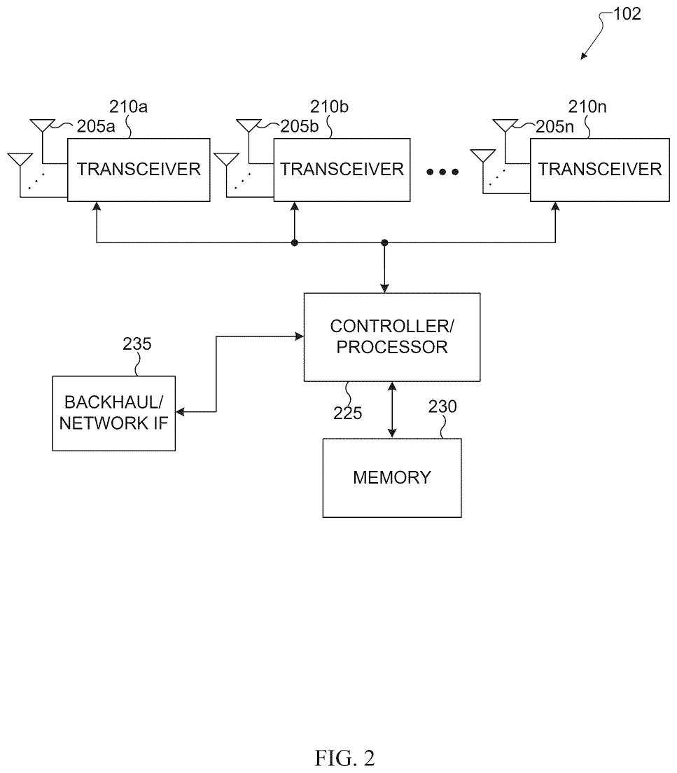

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for integrated synchronization signals. Any of a wide variety of other functions could be supported in the gNB 102 by the controller/processor 225.

The controller/processor 225 is also capable of executing programs and other processes resident in the memory 230, such as processes related to supporting integrated synchronization signals. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

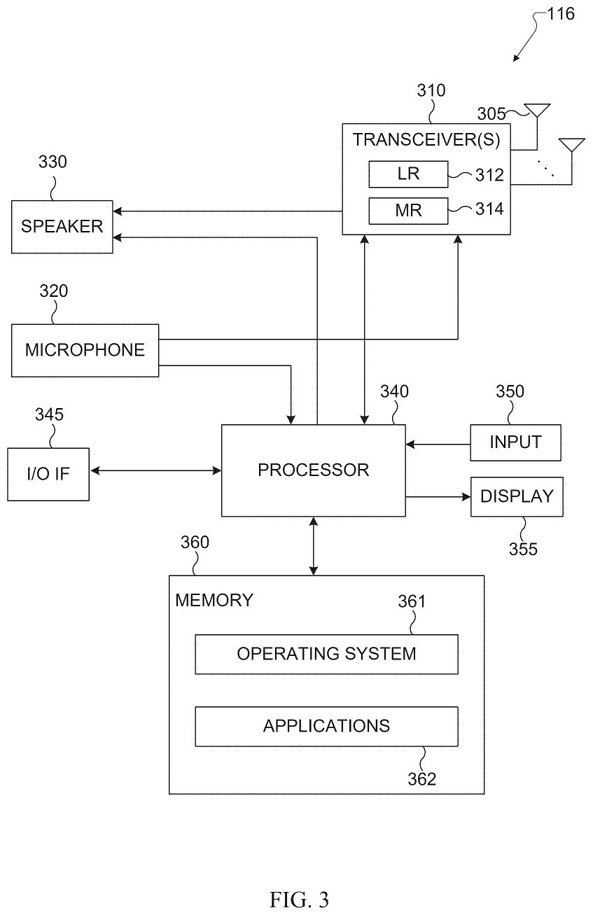

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for utilizing integrated synchronization signals as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

In various embodiments, the transceiver(s) 310 include or are at least one LR 312 and at least one MR 314. For example, as discussed in greater detail below, the LR 312 may be configured or utilized to receive low power signals (e.g., a LP-WUS or LP-SSB), for example, when the UE 116 is in a sleep state (e.g., such as an ultra-deep sleep state as discussed in greater detail below), while the MR 314 is powered off or in a low power state. For example, in some embodiments, the LR 312 may be a component of the transceiver(s) 310 used or powered on when the UE 116 is in the sleep state while the MR 314 is the transceiver(s) 310 and used when the UE 116 is not in the sleep state. In another example, in other embodiments, the LR 312 may be receiver that is separate or discrete from the transceivers(s) 310 which is the MR 314 used for ordinary reception operations when the UE 116 is not in the sleep state.

Analogously, in such embodiments, the processor 340 includes or is at least one of the low-power processor (LP) 342 and the main processor (MP) 344. For example, in some embodiments, the LR 312 and the MR 314 may be connected to and/or be controlled by the LP 342 and the MP 344, respectively, which are separate and/or discrete processors. In these embodiments, the LP 342 may operate at a lower power state than the MP 344 such that, when the UE is in the sleep state, the MP 344 may be powered off or in a low power state while the LP 342 can process any signals (e.g., such as a LP-WUS) received by the LR 312. In these embodiments, the operation of the LP 342 may consume less power than ordinary operations of the MP 344 would, thereby saving power of the UE 116 in the sleep state while maintaining the ability of the UE 116 to receive and process signals. In other embodiments, the LP 342 and the MP 344 may be components of the processor 340 where the LR 312 and the MR 314 may be connected to and/or be controlled by the LP 342 and the MP 344, respectively. In these embodiments, when the UE 116 is in the sleep state, MP 344 components of the processor 340 are powered off or in a low power state and LP 342 components operate to process signals (e.g., such as a LP-WUS) received by the LR 312. In these embodiments, the operation of the LP 342 components of the processor 340 may consume less power than ordinary operations of the processor 340 including the operations of the MP 344 components would, thereby saving power of the UE 116 in the sleep state while maintaining the ability of the UE 116 to receive and process signals.

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

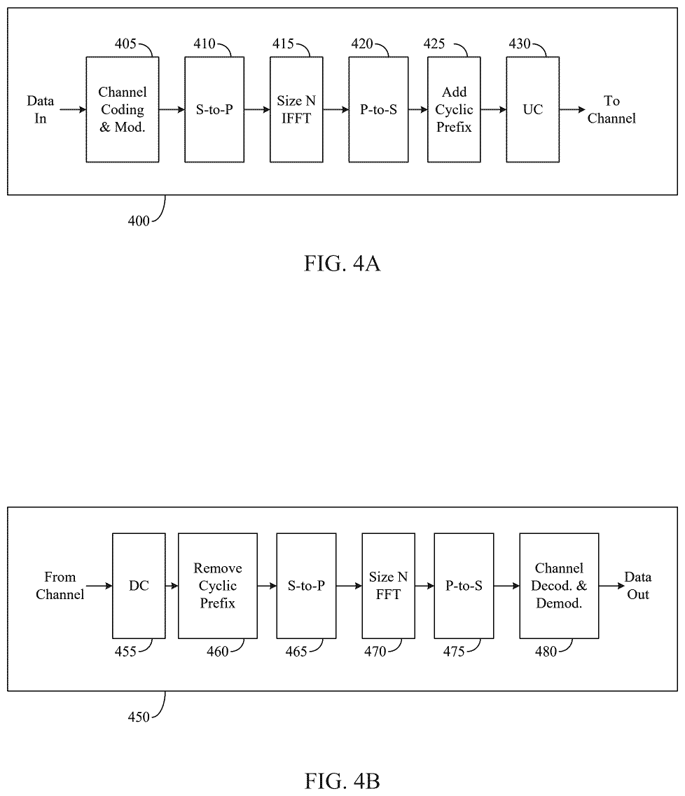

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured for integrated synchronization signals as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

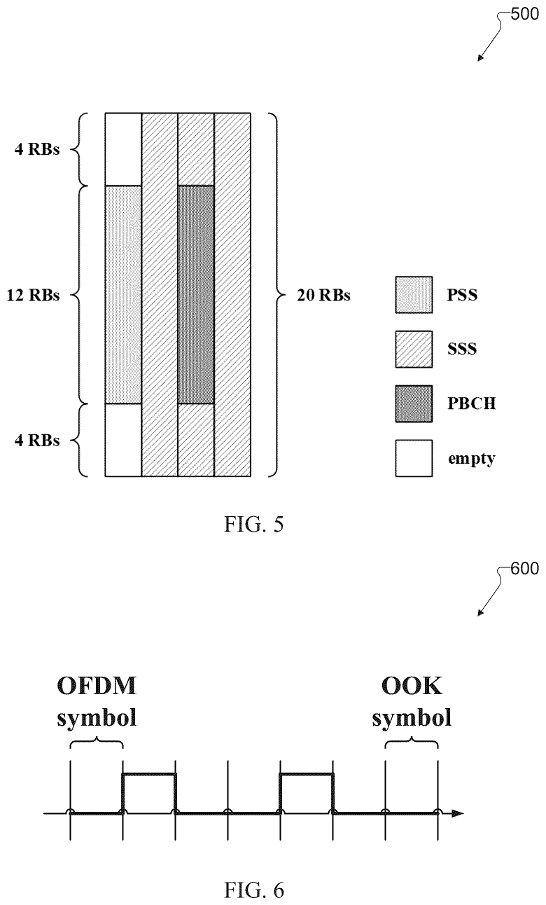

FIG. 5 illustrates an example SS/PBCH block architecture 500 according to embodiments of the present disclosure. For example, SS/PBCH block architecture 500 can be received by any of the UEs 111-116 of FIG. 1. This example is for illustration only and other embodiments can be used without departing from the scope of the present disclosure.

In NR Rel-15, each synchronization signals and physical broadcast channel (SS/PBCH) block compromises of four consecutive orthogonal frequency division multiplexing (OFDM) symbols, wherein the center 12 resource blocks (RBs) of the first symbol are mapped for primary synchronization signal (PSS), the second and forth symbols ae mapped for PBCH, and the third symbol is mapped for both secondary synchronization signal (SSS) and PBCH. An illustration of the SS/PBCH block composition is shown in FIG. 5. The same SS/PBCH composition is applied to supported carrier frequency ranges in NR, which spans from 0.41 GHz to 7.125 GHz as Frequency Range 1 (FR1), and spans from 24.25 to 52.6 GHz as Frequency Range 2 (FR2). In every RB mapped for PBCH, 3 out of the 12 resource elements (REs) are mapped for the demodulation reference signal (DM-RS) of PBCH, wherein the 3 REs are uniformly distributed in the RB and the starting location of the first RE is based on cell identity (ID).

FIG. 6 illustrates an example OOK waveform 600 according to embodiments of the present disclosure. For example, OOK waveform 600 can be received by any of the UEs 111-116 of FIG. 1, such as the UE 111. This example is for illustration only and other embodiments can be used without departing from the scope of the present disclosure.

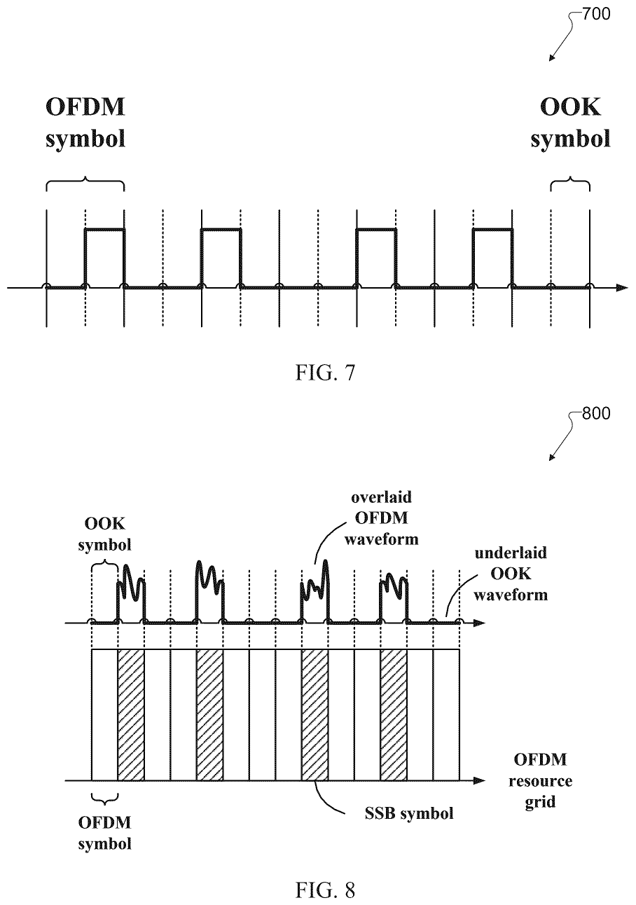

FIG. 7 illustrates an example OOK waveform 700 according to embodiments of the present disclosure. For example, OOK waveform 700 can be received by any of the UEs 111-116 of FIG. 1, such as the UE 116. This example is for illustration only and other embodiments can be used without departing from the scope of the present disclosure.

In NR Rel-19, OOK waveform based low-power synchronization signal (LP-SS) was introduced, wherein the signal can be used for synchronization procedure and radio resource management (RRM) measurement by a low-power receiver (LR). For the OOK waveform, one OFDM symbol can include one or multiple OOK symbols, wherein each OOK symbol corresponds to either ON or OFF. The ON-OFF pattern provided by the OOK waveform can be determined by a binary sequence, and different binary sequences can carry information for the LP-SS. An example of OOK waveform with one OOK symbol in an OFDM symbol is shown in FIG. 6, and an example of OOK waveform with two OOK symbols in an OFDM symbol is shown in FIG. 7.

For new generation of wireless communication, to save the energy of a UE, low-power receiver (LR) can be used for initial access. For this purpose, low power synchronization signal(s) and/or low power physical broadcast channel can be supported. Embodiments of the [resent disclosure recognize that detailed design for integrated waveform that can support both the low power synchronization signal(s) block (LP-SSB) (which include at least one low power synchronization signal, and may further include low power physical broadcast channel), and a synchronization signal(s) block (SSB) (which include at least one synchronization signal, and may further include physical broadcast channel) is needed.

This disclosure focuses on the synchronization signals with integrated waveforms that can be received by both a main receiver and a low power receiver. More precisely, the following aspects are included in the disclosure:
Integrated transmission of LP-SSB and SSB
   A first integration method
   A second integration method
   A third integration method
Example UE procedure

In one embodiment, based on a set of time and frequency domain resources, a base station (BS) can multiplex a transmission of a low power synchronization signal(s) block (LP-SSB) (which include at least one low power synchronization signal, and may further include low power physical broadcast channel) and a transmission of a synchronization signal(s) block (SSB) (which include at least one synchronization signal, and may further include physical broadcast channel).

For example, the LP-SSB can be transmitted using a first waveform, and the SSB can be transmitted using a second waveform, wherein the first waveform is different from the second waveform.

For one sub-example, the first waveform can be on off keying (OOK) waveform. For this OOK waveform, one or multiple OOK symbols can be included in one OFDM symbol, wherein each OOK symbol corresponds to either ON or OFF.

For another sub-example, the second waveform can be OFDM waveform. For one instance, the OFDM waveform can be overlaid over the OOK waveform.

The terms “overlaid waveform” and “underlaid waveform” refer to the combination of two different signal types. For example, OFDM waveform (overlaid) and an OOK waveform (underlaid), within the same time-frequency resources. The overlaid waveform carries standard SSB, while the underlaid waveform provides a LP-SSB. The combination enables both standard and low-power devices to access synchronization information efficiently. The following examples and figures illustrate examples of how these waveforms are multiplexed.

FIG. 8 illustrates a diagram of an example integrated synchronization signal 800 according to embodiments of the present disclosure. For example, integrated synchronization signal 800 can be received by any of the UEs 111-116 of FIG. 1, such as the UE 112. This example is for illustration only and other embodiments can be used without departing from the scope of the present disclosure.

In a first example, the OOK waveform can include one OOK symbol within one OFDM symbol, and/or an OOK waveform corresponding to one of the ON OOK symbols in a LP-SSB can be multiplexed with an OFDM waveform corresponding to one of the OFDM symbols in a SSB.

An illustration of the integration method is shown in FIG. 8.

In one aspect of this example, the following notations can be used:
A number of OOK symbols in a LP-SSB (or equivalently the number of OFDM symbols for this example) can be denoted as L_{LP-SSB}, which is a positive integer.
A number of ON OOK symbols in a LP-SSB (or equivalently the number of OFDM symbols for this example) can be denoted as L_{ON}, which is a positive integer.
A number of OFDM symbols in a SSB can be denoted as L_{SSB}, which is a positive integer.
A number of sequences, wherein each of the sequences determines the ON-OFF pattern in the OOK waveform for the LP-SSB, can be denoted as N_{LP-SSB}, which is a positive integer.

For one sub-example, L_{LP-SSB} can be pre-determined. In one implementation, the pre-determination can be based on a subcarrier spacing of the OFDM symbol that generates the OOK waveform for the LP-SSB. In another implementation, the pre-determination can be based on a frequency range of the band that supports the LP-SSB.
For one instance, L_{LP-SSB} can be an integer multiple of

$${N}_{symb}^{slot} ,$$

where

$${N}_{symb}^{slot}$$

is the number of OFDM symbols in a slot, e.g.,

$${N}_{symb}^{slot} = 14 ,$$

such as L_{LP-SSB}=14, or L_{LP-SSB}=28.
For another instance, L_{LP-SSB} can be in a form of L_{LP-SSB}=2^{m}−1, wherein m is a positive integer, such as L_{LP-SSB}=7, or L_{LP-SSB}=15, or L_{LP-SSB}=31.
For yet another instance, L_{LP-SSB} can be in a form of L_{LP-SSB}=2^{m}, wherein m is a positive integer, such as L_{LP-SSB}=4, or L_{LP-SSB}=8, or L_{LP-SSB}=16, or L_{LP-SSB}=32.
For yet another instance, L_{LP-SSB} can be an even number, such as L_{LP-SSB}=4, or L_{LP-SSB}=6, or L_{LP-SSB}=8, or L_{LP-SSB}=16, or L_{LP-SSB}=32.

For another sub-example, L_{LP-SSB} can be configured by a base station (BS). In one implementation, if the configuration is not provided to the UE, the UE (e.g., the UE 116) can expect a default value (or a pre-determined value) of L_{LP-SSB} according to sub-example or instance of this disclosure. In another implementation, candidate values for the configuration can be according to sub-example or instance of this disclosure.
For one instance, the configuration can be provided by system information (e.g., system information block #1 (SIB1), or other system information block (SIB)).
For another instance, the configuration can be provided by dedicated radio resource control (RRC) parameter.
For yet another instance, the configuration can be provided by a medium access control (MAC) control element (CE).
For yet another instance, the configuration can be provided by a downlink control information (DCI) format.

For one sub-example, L_{ON} can be pre-determined. In one implementation, the pre-determination can be based on a subcarrier spacing of the OFDM symbol that generates the OOK waveform for the LP-SSB. In another implementation, the pre-determination can be based on a frequency range of the band that supports the LP-SSB.
For one instance, L_{ON} can be determined based on L_{LP-SSB}, such as L_{ON}=L_{LP-SSB}/2.
For another instance, L_{ON} can be determined based on L_{SSB}, such as L_{ON}=L_{SSB}, Or L_{ON}=L_{SSB}·k wherein k is an integer such as k=2, or k=3, or k=4.
For yet another instance, L_{ON}≥L_{SSB}.
For yet another instance, within the L_{ON} ON OOK symbols, there are at least L_{SSB} consecutive OFDM symbols.
For yet another instance, L_{ON} can be the same for N_{LP-SSB} sequences that determines the ON-OFF pattern in the OOK waveform for the LP-SSB.

For another sub-example, L_{ON} can be configured by a BS. In one implementation, if the configuration is not provided to the UE, the UE can expect a default value (or a pre-determined value) of L_{ON} according to sub-example or instance of this disclosure. In another implementation, candidate values for the configuration can be according to sub-example or instance of this disclosure.
For one instance, the configuration can be provided by system information (e.g., SIB1, or other SIB).
For another instance, the configuration can be provided by dedicated RRC parameter.
For yet another instance, the configuration can be provided by a MAC CE.
For yet another instance, the configuration can be provided by a DCI format.

For one sub-example, N_{LP-SSB} can be pre-determined.
For one instance, N_{LP-SSB} can be fixed as 1, or 3, or 7, or 15.
For another instance, N_{LP-SSB} can be fixed as 2, or 4, or 6, or 8.
For yet another instance, N_{LP-SSB} can be same as a number of primary synchronization signal (PSS).
For yet another instance, N_{LP-SSB} can be same as a number of secondary synchronization signal (SSS).
For yet another instance, N_{LP-SSB} can be same as a number of physical cell identities.
For yet another instance, N_{LP-SSB} can be same as a number of groups of physical cell identities.

For another sub-example, N_{LP-SSB} can be configured by a BS. In one implementation, if the configuration is not provided to the UE, the UE can expect a default value (pre-determined value) of N_{LP-SSB} according to sub-example or instance of this disclosure. In another implementation, candidate values for the configuration can be according to sub-example or instance of this disclosure.
For one instance, the configuration can be provided by system information (e.g., SIB1, or other SIB).
For another instance, the configuration can be provided by dedicated RRC parameter.
For yet another instance, the configuration can be provided by a MAC CE.
For yet another instance, the configuration can be provided by a DCI format.

For one sub-example, one OFDM symbol of a SSB can be multiplexed to one of the ON OOK symbols in a LP-SSB.
For one instance, the i-th OFDM symbol of a SSB is multiplexed with the j-th ON OOK symbols in a LP-SSB, wherein i=j, 0≤i≤L_{SSB}−1, 0≤j≤L_{ON}−1, and L_{SSB}=L_{ON}.
For another instance, the i-th OFDM symbol of a SSB is multiplexed with the j-th ON OOK symbols in a LP-SSB, wherein i=j mod L_{SSB}, 0≤i≤L_{SSB}−1, 0≤j≤L_{ON}−1. In one implementation, this instance is applicable at least for L_{SSB}≤L_{ON}.
For yet another instance, the i-th OFDM symbol of a SSB is multiplexed with the j-th ON OOK symbols in a LP-SSB, wherein i=└j/(L_{ON}/L_{SSB})┘, 0≤i≤L_{SSB}−1, 0≤j≤ L_{ON}−1. In one implementation, this instance is applicable at least for L_{SSB}≤L_{ON}.

For one sub-example, when one OFDM symbol of a SSB is multiplexed to one of the ON OOK symbols in a LP-SSB, the multiplexing can be performed in the time domain. For instance, the generated signal in time domain can be denoted as s_{SSB}(t)·s_{LP-SSB}(t), wherein s_{SSB}(t) is the time domain signal for an OFDM symbol of the SSB, and s_{LP-SSB}(t) is the time domain signal for an ON OOK symbol of the LP-SSB.

For another sub-example, when one OFDM symbol of a SSB is multiplexed to one of the ON OOK symbols in a LP-SSB, the multiplexing can be performed in the frequency domain. For instance, the sequence or modulated sample for an OFDM symbol of the SSB can be mapped in the frequency domain to the subcarriers for an ON OOK symbol in the LP-SSB.

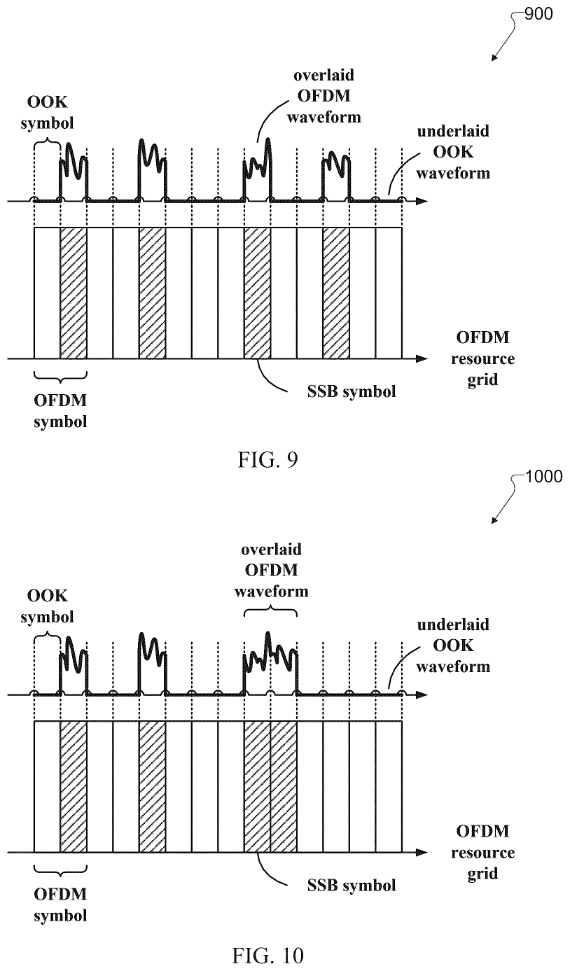

FIG. 9 illustrates an example integrated synchronization signal 900 according to embodiments of the present disclosure. For example, integrated synchronization signal 900 can be received by any of the UEs 111-116 of FIG. 1, such as the UE 114. This example is for illustration only and other embodiments can be used without departing from the scope of the present disclosure.

In a second example, the OOK waveform can include one or multiple OOK symbol(s) within one OFDM symbol, and/or an OOK waveform corresponding to one of the ON OOK symbols in a LP-SSB can be multiplexed with an OFDM waveform corresponding to one of the OFDM symbols in a SSB.

An illustration of the integration method is shown in FIG. 9.

In one aspect of this example, the following notations can be used:
A number of OOK symbols in a LP-SSB can be denoted as L_{LP-SSB}, which is a positive integer. The L_{LP-SSB} can also be expressed as L_{LP-SSB}=M·N, wherein M is the number of OOK symbols in a OFDM symbol (e.g., M can be pre-defined, or configured by higher layer parameter such as from candidate values of {1, 2, 4}), and N is the number of OFDM symbols in a LP-SSB (e.g., N can be pre-defined, or configured by higher layer parameter).
In one implementation, a UE can expect L_{LP-SSB}/M is an integer. In another implementation, a UE can expect L_{LP-SSB}/N is an integer.
A number of ON OOK symbols in a LP-SSB can be denoted as L_{ON}, which is a positive integer.
A number of OFDM symbols in a SSB can be denoted as L_{SSB}, which is a positive integer.
A number of sequences, wherein each of the sequences determines the ON-OFF pattern in the OOK waveform for the LP-SSB, can be denoted as N_{LP-SSB}, which is a positive integer.

For one sub-example, L_{LP-SSB} can be pre-determined. In one implementation, the pre-determination can be based on a subcarrier spacing of the OFDM symbol that generates the OOK waveform for the LP-SSB. In another implementation, the pre-determination can be based on a frequency range of the band that supports the LP-SSB.
For one instance, L_{LP-SSB} can be an integer multiple of

$${N}_{symb}^{slot} ,$$

where

$${N}_{symb}^{slot}$$

is the number of OFDM symbols in a slot, e.g.,

$${N}_{symb}^{slot} = 14 ,$$

such as L_{LP-SSB}=14, or L_{LP-SSB}=28, or L_{LP-SSB}=14·M, or L_{LP-SSB}=28·M.
For another instance, L_{LP-SSB} can be in a form of L_{LP-SSB}=2^{m}−1, wherein m is a positive integer, such as L_{LP-SSB}=7, or L_{LP-SSB}=15, or L_{LP-SSB}=31.
For yet another instance, L_{LP-SSB} can be in a form of L_{LP-SSB}=2^{m}, wherein m is a positive integer, such as L_{LP-SSB}=4, or L_{LP-SSB}=8, or L_{LP-SSB}=16, or L_{LP-SSB}=32.
For yet another instance, L_{LP-SSB} can be an even number, such as L_{LP-SSB}=4, or L_{LP-SSB}=6, or L_{LP-SSB}=8, or L_{LP-SSB}=16, or L_{LP-SSB}=32.

For another sub-example, L_{LP-SSB} can be configured by a base station (BS). In one implementation, if the configuration is not provided to the UE, the UE can expect a default value (pre-determined value) of L_{LP-SSB} according to sub-example or instance of this disclosure. In another implementation, candidate values for the configuration can be according to sub-example or instance of this disclosure.
For one instance, the configuration can be provided by system information (e.g., SIB1, or other SIB).
For another instance, the configuration can be provided by dedicated RRC parameter.
For yet another instance, the configuration can be provided by a MAC CE.
For yet another instance, the configuration can be provided by a DCI format.

For one sub-example, L_{ON} can be pre-determined. In one implementation, the pre-determination can be based on a subcarrier spacing of the OFDM symbol that generates the OOK waveform for the LP-SSB. In another implementation, the pre-determination can be based on a frequency range of the band that supports the LP-SSB.
For one instance, L_{ON} can be determined based on L_{LP-SSB}, such as L_{ON}=L_{LP-SSB}/2.
For another instance, L_{ON} can be determined based on L_{SSB}, such as L_{ON}=L_{SSB}, or L_{ON}=L_{SSB}·k wherein k is an integer such as k=2, or k=3, or k=4.
For yet another instance, L_{ON}≥L_{SSB}.
For yet another instance, within the L_{ON} ON OOK symbols, there are at least L_{SSB} consecutive OFDM symbols.
For yet another instance, L_{ON} can be the same for N_{LP-SSB} sequences that determines the ON-OFF pattern in the OOK waveform for the LP-SSB.
For yet another instance, the M OOK symbols in an OFDM symbol can be ON OOK symbols.

For another sub-example, L_{ON} can be configured by a BS. In one implementation, if the configuration is not provided to the UE, the UE can expect a default value (or a pre-determined value) of L_{ON} according to sub-example or instance of this disclosure. In another implementation, candidate values for the configuration can be according to sub-example or instance of this disclosure.
For one instance, the configuration can be provided by system information (e.g., SIB1, or other SIB).
For another instance, the configuration can be provided by dedicated RRC parameter.
For yet another instance, the configuration can be provided by a MAC CE.
For yet another instance, the configuration can be provided by a DCI format.

For one sub-example, N_{LP-SSB} can be pre-determined.
For one instance, N_{LP-SSB} can be fixed as 1, or 3, or 7, or 15.
For another instance, N_{LP-SSB} can be fixed as 2, or 4, or 6, or 8.
For yet another instance, N_{LP-SSB} can be same as a number of primary synchronization signal (PSS).
For yet another instance, N_{LP-SSB} can be same as a number of secondary synchronization signal (SSS).
For yet another instance, N_{LP-SSB} can be same as a number of physical cell identities.
For yet another instance, N_{LP-SSB} can be same as a number of groups of physical cell identities.

For another sub-example, N_{LP-SSB} can be configured by a BS. In one implementation, if the configuration is not provided to the UE, the UE can expect a default value (pre-determined value) of N_{LP-SSB} according to sub-example or instance of this disclosure. In another implementation, candidate values for the configuration can be according to sub-example or instance of this disclosure.
For one instance, the configuration can be provided by system information (e.g., SIB1, or other SIB).
For another instance, the configuration can be provided by dedicated RRC parameter.
For yet another instance, the configuration can be provided by a MAC CE.
For yet another instance, the configuration can be provided by a DCI format.

For one sub-example, one OFDM symbol of a SSB can be multiplexed to one of the ON OOK symbols in a LP-SSB.
For one instance, the i-th OFDM symbol of a SSB is multiplexed with the j-th ON OOK symbols in a LP-SSB, wherein i=j, 0≤i≤L_{SSB}−1, 0≤j≤L_{ON}−1, and L_{SSB}=L_{ON}.
For another instance, the i-th OFDM symbol of a SSB is multiplexed with the j-th ON OOK symbols in a LP-SSB, wherein i=j mod L_{SSB}, 0≤i≤L_{SSB}−1, 0≤j≤L_{ON}−1. In one implementation, this instance is applicable at least for L_{SSB}≤L_{ON}.
For yet another instance, the i-th OFDM symbol of a SSB is multiplexed with the j-th ON OOK symbols in a LP-SSB, wherein i=└j/(L_{ON}/L_{SSB})┘, 0≤i≤L_{SSB}−1, 0≤j≤ L_{ON}−1. In one implementation, this instance is applicable at least for L_{SSB}≤L_{ON}.

For one sub-example, when one OFDM symbol of a SSB is multiplexed to one of the ON OOK symbols in a LP-SSB, the multiplexing can be performed in the time domain. For instance, the generated signal in time domain can be denoted as s_{SSB}(t)·s_{LP-SSB}(t), wherein s_{SSB}(t) is the time domain signal for an OFDM symbol of the SSB, and s_{LP-SSB}(t) is the time domain signal for an ON OOK symbol of the LP-SSB.

For another sub-example, when one OFDM symbol of a SSB is multiplexed to one of the ON OOK symbols in a LP-SSB, the multiplexing can be performed in the frequency domain. For instance, the sequence or modulated sample for an OFDM symbol of the SSB can be mapped in the frequency domain to the subcarriers for an ON OOK symbol in the LP-SSB.

FIG. 10 illustrates an example integrated synchronization signal 1000 according to embodiments of the present disclosure. For example, integrated synchronization signal 1000 can be received by any of the UEs 111-116 of FIG. 1, such as the UE 116. This example is for illustration only and other embodiments can be used without departing from the scope of the present disclosure.

In a third example, the OOK waveform can include one or multiple OOK symbol(s) within one OFDM symbol, and/or an OOK waveform corresponding to the one or multiple OOK symbols in an OFDM symbol can be multiplexed with an OFDM waveform corresponding to one of the OFDM symbols in a SSB, wherein e.g., the one or multiple OOK symbols in a OFDM symbol includes at least one ON OOK symbol.

An illustration of the integration method is shown in FIG. 10.

In one aspect of this example, the following notations can be used:
A number of OOK symbols in a LP-SSB can be denoted as L_{LP-SSB}, which is a positive integer. The L_{LP-SSB} can also be expressed as L_{LP-SSB}=M·N, wherein M is the number of OOK symbols in a OFDM symbol (e.g., M can be pre-defined, or configured by higher layer parameter such as from candidate values of {1, 2, 4}), and N is the number of OFDM symbols in a LP-SSB (e.g., N can be pre-defined, or configured by higher layer parameter). In one implementation, a UE can expect L_{LP-SSB}/M is an integer. In another implementation, a UE can expect L_{LP-SSB}/N is an integer.
A number of ON OOK symbols in a LP-SSB can be denoted as L_{ON}, which is a positive integer.
A number of OFDM symbols in a SSB can be denoted as L_{SSB}, which is a positive integer.
A number of sequences, wherein each of the sequences determines the ON-OFF pattern in the OOK waveform for the LP-SSB, can be denoted as N_{LP-SSB}, which is a positive integer.

For one sub-example, L_{LP-SSB} can be pre-determined. In one implementation, the pre-determination can be based on a subcarrier spacing of the OFDM symbol that generates the OOK waveform for the LP-SSB. In another implementation, the pre-determination can be based on a frequency range of the band that supports the LP-SSB.
For one instance, L_{LP-SSB} can be an integer multiple of

$${N}_{symb}^{slot} ,$$

where

$${N}_{symb}^{slot}$$

is the number where of OFMD symbols in a slot, e.g.,

$${N}_{symb}^{slot} = 14 ,$$

such as L_{LP-SSB}=14, or L_{LP-SSB}=28, or L_{LP-SSB}=14·M, or L_{LP-SSB}=28·M.
For another instance, L_{LP-SSB} can be in a form of L_{LP-SSB}=2^{m}−1, wherein m is a positive integer, such as L_{LP-SSB}=7, or L_{LP-SSB}=15, or L_{LP-SSB}=31.
For yet another instance, L_{LP-SSB} can be in a form of L_{LP-SSB}=2^{m}, wherein m is a positive integer, such as L_{LP-SSB}=4, or L_{LP-SSB}=8, or L_{LP-SSB}=16, or L_{LP-SSB}=32.
For yet another instance, L_{LP-SSB} can be an even number, such as L_{LP-SSB}=4, or L_{LP-SSB}=6, or L_{LP-SSB}=8, or L_{LP-SSB}=16, or L_{LP-SSB}=32.

For another sub-example, L_{LP-SSB} can be configured by a base station (BS). In one implementation, if the configuration is not provided to the UE, the UE can expect a default value (pre-determined value) of L_{LP-SSB} according to sub-example or instance of this disclosure. In another implementation, candidate values for the configuration can be according to sub-example or instance of this disclosure.
For one instance, the configuration can be provided by system information (e.g., SIB1, or other SIB).
For another instance, the configuration can be provided by dedicated RRC parameter.
For yet another instance, the configuration can be provided by a MAC CE.
For yet another instance, the configuration can be provided by a DCI format.

For one sub-example, L_{ON} can be pre-determined. In one implementation, the pre-determination can be based on a subcarrier spacing of the OFDM symbol that generates the OOK waveform for the LP-SSB. In another implementation, the pre-determination can be based on a frequency range of the band that supports the LP-SSB.
For one instance, L_{ON} can be determined based on L_{LP-SSB}, such as L_{ON}=L_{LP-SSB}/2.
For another instance, L_{ON} can be determined based on L_{SSB}, such as L_{ON}=L_{SSB}, Or L_{ON}=L_{SSB}·k wherein k is an integer such as k=2, or k=3, or k=4.
For yet another instance, L_{ON}≥L_{SSB}.
For yet another instance, within the L_{ON} ON OOK symbols, there are at least L_{SSB} consecutive OFDM symbols.
For yet another instance, L_{ON} can be the same for N_{LP-SSB} sequences that determines the ON-OFF pattern in the OOK waveform for the LP-SSB.
For yet another instance, the M OOK symbols in an OFDM symbol can be ON OOK symbols.
For yet another instance, within each OFDM symbol in a LP-SSB, a UE can expect at least one OOK symbol corresponds to an ON OOK symbol.

For another sub-example, L_{ON} can be configured by a BS. In one implementation, if the configuration is not provided to the UE, the UE (e.g., the U E116) can expect a default value (pre-determined value) of L_{ON} according to sub-example or instance of this disclosure. In another implementation, candidate values for the configuration can be according to sub-example or instance of this disclosure.
For one instance, the configuration can be provided by system information (e.g., SIB1, or other SIB).
For another instance, the configuration can be provided by dedicated RRC parameter.
For yet another instance, the configuration can be provided by a MAC CE.
For yet another instance, the configuration can be provided by a DCI format.

For one sub-example, N_{LP-SSB} can be pre-determined.
For one instance, N_{LP-SSB} can be fixed as 1, or 3, or 7, or 15.
For another instance, N_{LP-SSB} can be fixed as 2, or 4, or 6, or 8.
For yet another instance, N_{LP-SSB} can be same as a number of primary synchronization signal (PSS).
For yet another instance, N_{LP-SSB} can be same as a number of secondary synchronization signal (SSS).
For yet another instance, N_{LP-SSB} can be same as a number of physical cell identities.
For yet another instance, N_{LP-SSB} can be same as a number of groups of physical cell identities.

For another sub-example, N_{LP-SSB} can be configured by a BS. In one implementation, if the configuration is not provided to the UE, the UE can expect a default value (pre-determined value) of N_{LP-SSB} according to sub-example or instance of this disclosure. In another implementation, candidate values for the configuration can be according to sub-example or instance of this disclosure.
For one instance, the configuration can be provided by system information (e.g., SIB1, or other SIB).
For another instance, the configuration can be provided by dedicated RRC parameter.
For yet another instance, the configuration can be provided by a MAC CE.
For yet another instance, the configuration can be provided by a DCI format.

For one sub-example, one OFDM symbol of a SSB can be multiplexed to one of the OFDM symbols in a LP-SSB. In one implementation, the OFDM symbol includes at least one ON OOK symbol. Denoting the number of OFDM symbols in a LP-SSB as N_{ON}, wherein the OFDM symbol includes at least one ON OOK symbol (e.g., N_{ON}≤L_{ON}).
For one instance, the i-th OFDM symbol of a SSB is multiplexed with the j-th OFDM symbols in a LP-SSB, wherein i=j, 0≤i≤L_{SSB}−1, 0≤j≤N_{ON}−1, and L_{SSB}=N_{ON}.
For another instance, the i-th OFDM symbol of a SSB is multiplexed with the j-th ON OOK symbols in a LP-SSB, wherein i=j mod L_{SSB}, 0≤i≤L_{SSB}−1, 0≤j≤N_{ON}−1. In one implementation, this instance is applicable at least for L_{SSB}≤N_{ON}.
For yet another instance, the i-th OFDM symbol of a SSB is multiplexed with the j-th ON OOK symbols in a LP-SSB, wherein i=└j/(N_{ON}/L_{SSB})┘, 0≤i≤L_{SSB}−1, 0≤j≤ N_{ON}−1. In one implementation, this instance is applicable at least for L_{SSB}≤N_{ON}.

For one sub-example, when one OFDM symbol of a SSB is multiplexed to one of the ON OOK symbols in a LP-SSB, the multiplexing can be performed in the time domain. For instance, the generated signal in time domain can be denoted as s_{SSB}(t)·s_{LP-SSB}(t), wherein s_{SSB}(t) is the time domain signal for an OFDM symbol of the SSB, and s_{LP-SSB}(t) is the time domain signal for an OFDM symbol including at least one ON OOK symbol of the LP-SSB.

For another sub-example, when one OFDM symbol of a SSB is multiplexed to one of the ON OOK symbols in a LP-SSB, the multiplexing can be performed in the frequency domain. For instance, the sequence or modulated sample for an OFDM symbol of the SSB can be mapped in the frequency domain to the subcarriers for an ON OOK symbol in the LP-SSB.

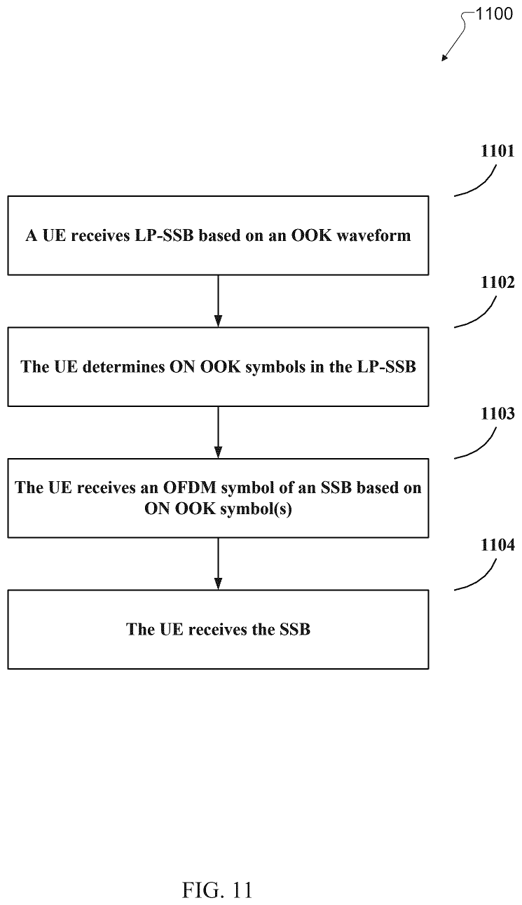

FIG. 11 illustrates a flowchart of an example UE procedure 1100 for receiving integrated LP-SSB and SSB according to embodiments of the present disclosure. For example, procedure 1100 can be performed by the UE 116 of FIG. 3. This example is for illustration only and other embodiments can be used without departing from the scope of the present disclosure.

For one embodiment, an example UE procedure for receiving the multiplexed LP-SSB and SSB is illustrated in FIG. 11. The procedure begins in 1101, a UE receives LP-SSB based on an OOK waveform. In 1102, the UE determines ON OOK symbols in the LP-SSB. In 1103, the UE receives an OFDM symbol of an SSB based on ON OOK symbol(s). In 1104, the UE receives the SSB.

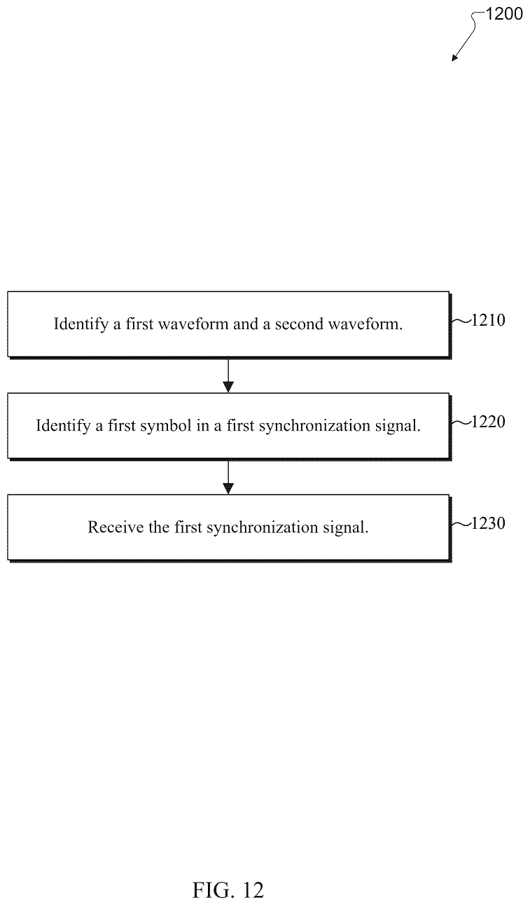

FIG. 12 illustrates an example method 1200 performed by a UE in a wireless communication system according to embodiments of the present disclosure. The method 1200 of FIG. 12 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1200 is for illustration only and other embodiments can be used without departing from the scope of the present disclosure.

The method 1200 begins with the UE identifying a first waveform and a second waveform (1210). For example, in 1210, the first waveform is an OOK waveform and the second waveform is an OFDM waveform.

The UE then identifies a first symbol in a first synchronization signal (1220). For example, in 1220, the first symbol is a second symbol using the second waveform multiplexed over a third symbol using the first waveform. In one example, the second symbol corresponds to an OFDM symbol in a second synchronization signal. In one example, the third symbol corresponds to an ON symbol in the OOK waveform. In various embodiments, the UE identifies L_{ON} ON symbols within the first synchronization signal and identifies L_{SSB} OFDM symbols within the second synchronization signal, where L_{ON}=L_{SSB}. The UE then receives the first synchronization signal (1230).

In various embodiments, the UE identifies M OOK symbols within an OFDM symbol, identifies N OFDM symbols within the first synchronization signal, and determines a third number of OOK symbols within the first synchronization signal as N_{LP-SSB}=M·N. In one example, the first number and the second number are provided by higher layer parameters.

Any of the above variation embodiments can be utilized independently or in combination with at least one other variation embodiment. The above flowchart illustrates example methods that can be implemented in accordance with the principles of the present disclosure and various changes could be made to the methods illustrated in the flowchart herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a processor configured to:
identify a first waveform and a second waveform; and
identify a first symbol in a first synchronization signal, the first symbol being a second symbol using the second waveform multiplexed over a third symbol using the first waveform; and
a transceiver operably coupled to the processor, the transceiver configured to receive the first synchronization signal.

2. The UE of claim 1, wherein:
the first waveform is an ON-OFF keying (OOK) waveform, and
the second waveform is an orthogonal frequency division multiplexing (OFDM) waveform.

3. The UE of claim 2, wherein the third symbol corresponds to an ON symbol in the OOK waveform.

4. The UE of claim 2, wherein the second symbol corresponds to an OFDM symbol in a second synchronization signal.

5. The UE of claim 4, wherein the processor is further configured to:
identify a first number (L_{ON}) of ON symbols within the first synchronization signal; and
identify a second number (L_{SSB}) of OFDM symbols within the second synchronization signal,
wherein L_{ON}=L_{SSB}.

6. The UE of claim 1, wherein:
the first waveform is an ON-OFF keying (OOK) waveform,
the second waveform is an orthogonal frequency division multiplexing (OFDM) waveform, and
the processor is further configured to:
identify a first number (M) of OOK symbols within an OFDM symbol;
identify a second number (N) of OFDM symbols within the first synchronization signal; and
determine a third number of OOK symbols within the first synchronization signal as N_{LP-SSB}=M·N.

7. The UE of claim 6, wherein the first number and the second number are provided by higher layer parameters.

8. A method of a user equipment (UE) in a wireless communication system, the method comprising:
identifying a first waveform and a second waveform;
identifying a first symbol in a first synchronization signal, the first symbol being a second symbol using the second waveform multiplexed over a third symbol using the first waveform; and
receiving the first synchronization signal.

9. The method of claim 8, wherein:
the first waveform is an ON-OFF keying (OOK) waveform, and
the second waveform is an orthogonal frequency division multiplexing (OFDM) waveform.

10. The method of claim 9, wherein the third symbol corresponds to an ON symbol in the OOK waveform.

11. The method of claim 9, wherein the second symbol corresponds to an OFDM symbol in a second synchronization signal.

12. The method of claim 10, further comprising:
identifying a first number (L_{ON}) of ON symbols within the first synchronization signal; and
identifying a second number (L_{SSB}) of OFDM symbols within the second synchronization signal,
wherein L_{ON}=L_{SSB}.

13. The method of claim 8, wherein:
the first waveform is an ON-OFF keying (OOK) waveform,
the second waveform is an orthogonal frequency division multiplexing (OFDM) waveform, and
the method further comprises:
identifying a first number (M) of OOK symbols within an OFDM symbol;
identifying a second number (N) of OFDM symbols within the first synchronization signal; and
determining a third number of OOK symbols within the first synchronization signal as N_{LP-SSB}=M·N.

14. The method of claim 13, wherein the first number and the second number are provided by higher layer parameters.

15. A base station (BS) in a wireless communication system, the BS comprising:
a processor configured to:
determine a first waveform and a second waveform; and
multiplex a second symbol using the second waveform over a third symbol using the first waveform to generate a first symbol in a first synchronization signal; and
a transceiver operably coupled to the processor, the transceiver configured to transmit the first synchronization signal.

16. The BS of claim 15, wherein the first waveform is an ON-OFF keying (OOK) waveform, and the second waveform is an orthogonal frequency division multiplexing (OFDM) waveform.

17. The BS of claim 16, wherein the third symbol corresponds to an ON symbol in the OOK waveform.

18. The BS of claim 16, wherein the processor is further configured to:
determine a first number (M) of OOK symbols within an OFDM symbol;
determine a second number (N) of OFDM symbols within the first synchronization signal; and
determine a third number of OOK symbols within the first synchronization signal as N_{LP-SSB}=M·N,
wherein the first number and the second number are provided by higher layer parameters.

19. The BS of claim 16, wherein the second symbol corresponds to an OFDM symbol in a second synchronization signal.

20. The BS of claim 19, wherein the processor is further configured to:
determine a first number (L_{ON}) of ON symbols within the first synchronization signal; and
determine a second number (L_{SSB}) of OFDM symbols within the second synchronization signal,
wherein L_{ON}=L_{SSB}.
